(19) United States
(12) Patent Application Publication
(10) Pub. No.: US 2026/0095207 A1
(43) Pub. Date: Apr. 2, 2026

(54) COMMUNICATION SYSTEM FOR AUGMENTED HUMAN-OBJECT INTERACTION

(71) Applicant: Quasistatics Inc., West Lafayette, IN (US)

(72) Inventors: Shreyas Sen, West Lafayette, IN (US); Samyadip Sarkar, West Lafayette, IN (US); David Yang, West Lafayette, IN (US)

(21) Appl. No.: 18/901,578

(22) Filed: Sep. 30, 2024

(51) Int. Cl. H04B 5/73; H04B 5/22; H04B 5/48; H04B 13/00

(52) U.S. Cl. CPC H04B 5/73; H04B 5/22; H04B 5/48; H04B 13/005

(57) ABSTRACT

Embodiments of the present disclosure relates to a communication system for augmented human-object interaction. The communication system includes, a wearable device to transmit and receive electro-quasistatic signals (EQSs) carrying data with a receiving device. Further, a conducting medium carries the EQS signals to one or more surrounding objects using a human body communication network. One or more surrounding objects augmented with conductive parts to enable application-specific interaction with the wearable device. Furthermore, communication link established between wearable device and conductive parts is based on EQS Body Coupled Communication network. Communication link ensures non-radiative signal confinement around a human body and the conductive parts of the one or more surrounding objects. Receiving device receives the EQS signals from the wearable device via the conducting medium and the one or more surrounding objects.

### FIELD OF INVENTION

The present disclosure generally relates to the field of communication between wearable devices, more particularly relates to a communication system for augmented human-object interaction.

### BACKGROUND

Generally, communication is defined as exchanging of an information over a medium. A medium is a channel through which an information is exchanged between a transmitter and a receiver. A human body, like any other medium of communication, may be used as a medium for communication. In a Human Body Communication (HBC), the human body is utilized as a communication medium between devices on and around the human body. Thus, providing enhanced interaction between human body and physical objects in the physical world through the integration of digital technology. The physical objects are embedded with virtual elements, which enable users to interact.

Human body centered communication links, which are essential for wearable devices and human-object interaction systems, have traditionally relied on radio frequency (RF) based wireless communication techniques. During the RF communication data may be transmitted over long distances by using simple hardware components. However, radiative nature of the RF communication poses several significant challenges, especially in the context of body-centric applications.

One major concern with the RF-based communication relates to high power consumption. Wearable devices, such as smartwatches, fitness trackers, and health monitoring systems, operate on limited battery power. The RF communication typically consumes power at levels ranging from milliwatts (mW) to watts (W), which may drain a device's battery quickly.

Further, the radiative nature of the RF communication creates security vulnerabilities. The RF signals broadcast data over the air, which enable interception and unauthorized access. The human body centered communication links transmit sensitive personal data such as health metrics, location, or biometric information. Thus, the risk of unauthorized access or hacking of the personal data leads to privacy breaches and/or manipulation of the information, posing risks to user safety and confidentiality.

Another challenge associated with the RF-based communication in the human body-centered applications is signal interference and attenuation. The human body is a complex structure that may absorb and reflect the RF signals, leading to a reduction in signal strength and reliability. The attenuation is particularly problematic when the device needs to communicate through or around the body, such as between wearable sensors placed on different parts of the body. The inconsistency in signal transmission may lead to unreliable communication, reducing the overall performance of the system.

Therefore, there is need of more robust and reliable communication system for enabling augmented human-object interaction to address the aforementioned issues.

### SUMMARY

This summary is provided to introduce a selection of concepts, in a simple manner which is further described in the detailed description of the disclosure. This summary is neither intended to identify key or essential inventive concepts of the subject matter nor to determine the scope of the disclosure.

In accordance with an embodiment of the present disclosure, a communication system for augmented human-object interaction is disclosed. The system includes a wearable device configured to transmit and receive electro-quasistatic signals (EQSs) carrying data with a receiving device. Further, the system includes a conducting medium configured to carry the EQS signals from the wearable device to one or more surrounding objects using a human body communication network. Further, the one or more surrounding objects are augmented with conducting parts to enable application-specific interaction with the wearable device. The one or more surrounding objects are in proximity with the conductive medium. Further, the conducting parts are configured to forward the EQS signals from the conducting medium to the receiving device. Further, the system includes a communication link established between the wearable device and the conducting parts of the surrounding objects. The communication link is based on EQS Body Coupled Communication network. The communication link is configured to ensure non-radiative signal confinement around a human body and the conductive parts of the one or more surrounding objects. Further, the system includes the receiving device configured to receive the EQS signals from the wearable device via the conducting medium and the one or more surrounding objects.

In another aspect of the present disclosure, a method of communication system for augmenting human-object interaction is disclosed. The method includes, determining, by a processor, one or more surrounding objects in proximity to a conductive medium for transmitting an electro-quasistatic (EQS) signal carrying data from a wearable device to a receiving device. The one or more surrounding object including conducting parts. Further, the method includes configuring, by the processor, the one or more surrounding objects with conducting parts that guide the EQS signals. Further, the method includes establishing, by the processor, a communication channel between the wearable device and the receiving device via the conducting medium and the conducting parts. Further, the method includes transmitting, by the processor, the electro-quasistatic (EQS) signal carrying data from the wearable device to the receiving device via the conducting medium and the conducting parts using a non-radiative, guided communication mode maintaining signal confinement around the user and the conducting parts.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1A illustrates a schematic diagram representation of an exemplary communication system for augmenting human-object interaction, in accordance with an embodiment of the present disclosure;

FIG. 1B illustrates a schematic diagram representation of an exemplary communication system for augmenting human-object interaction in Electro-Quasistatic (EQS), in accordance with another embodiment of the present disclosure;

FIG. 2A illustrates a block diagram representation of an exemplary wearable device for augmenting human-object interaction in EQS, in accordance with an embodiment of the present disclosure;

FIG. 2B illustrates an exemplary block diagram representation of a receiving device for augmenting human-object interaction in EQS, in accordance with an embodiment of the present disclosure;

FIG. 3 illustrates an exemplary schematic diagram representation of a human body interacting with a conducting part in EQS, in accordance with an embodiment of the present disclosure;

FIG. 4 illustrates an exemplary schematic diagram representation of a Finite Element Method (FEM)-based setup for numerical simulation of human-object interaction in EQS, in an accordance with an embodiment of the present disclosure;

FIG. 5 illustrates an exemplary graphical representation of human-object interaction channel characteristics during presence of conducting structure, in accordance with an embodiment of the present disclosure;

FIG. 6 illustrates an exemplary graphical representation of the variability in channel gain characteristics with the width variation of the incorporated conducting part during touch-based interactions, in accordance with an embodiment of the present disclosure;

FIG. 7 illustrates an exemplary graphical representation of the channel gain dependency on the variation in the length of the conducting part, in an accordance with an embodiment of the present disclosure;

FIG. 8 illustrates an exemplary schematic diagram representation of the dependency of channel specificity on application-specific patterning of the incorporated conducting part, in accordance with an embodiment of the present disclosure;

FIG. 9 illustrates a schematic diagram representation of a non-radiative interactions between one or more human body via conducting parts by enabling Human-Structure-Human Interaction (HSHI) in EQS, in an accordance with an embodiment of the present disclosure;

FIG. 10 illustrates a schematic diagram representation of an exemplary circuitry of Human-Structure-Human Interaction (HSHI) in EQS, in an accordance with an embodiment of the present disclosure;

FIG. 11 illustrates a schematic diagram representation of an exemplary Finite Element Method (FEM)-based setup for numerical simulation of Human-Structure-Human Interaction (HSHI) in EQS, in accordance with an embodiment of the present disclosure;

FIG. 12 illustrates a graphical diagram representation of the presence of the conducting part on the HSHI channel, in accordance with an embodiment of the present disclosure; and

FIG. 13 illustrates an exemplary process flow diagram representation of a method for augmenting human-object interaction, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Embodiments of the present disclosure provide a system of enabling augmentation between computing devices associated with human body and conducting objects in an environment.

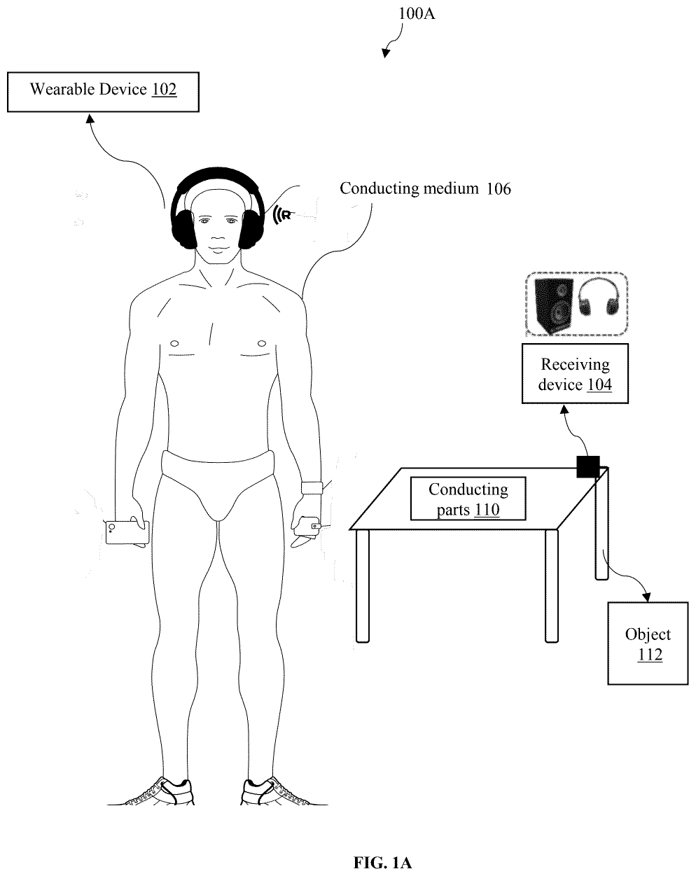

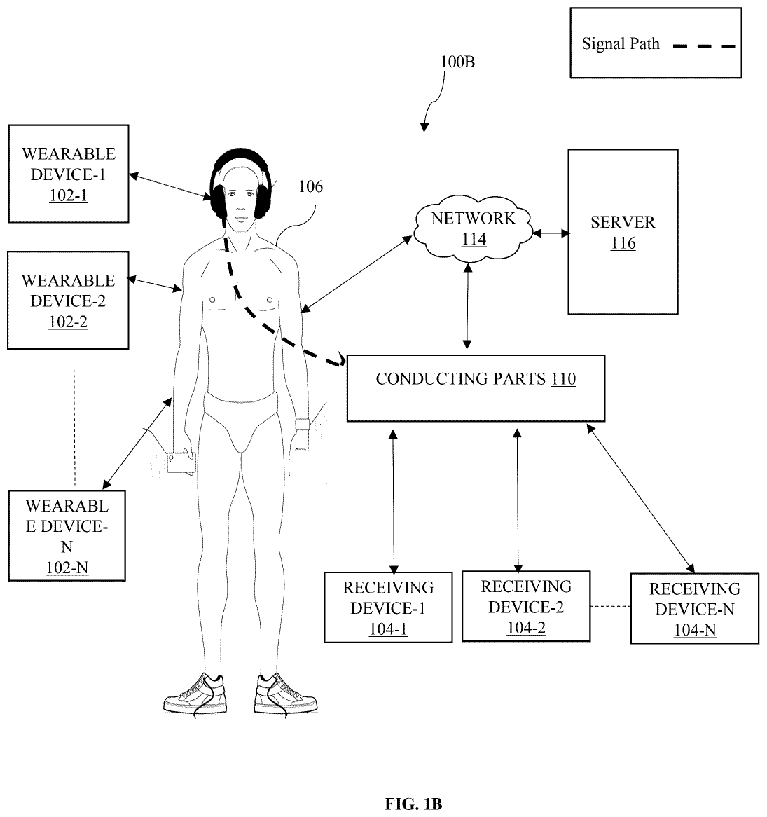

Referring now to the drawings, and more particularly to FIG. 1 through FIG. 13, where similar reference characters denote corresponding features consistently throughout the figures, there are shown preferred embodiments and these embodiments are described in the context of the following exemplary system and/or method.

FIG. 1A illustrates a schematic diagram representation of an exemplary communication system 100 for augmenting human-object interaction, in accordance with an embodiment of the present disclosure. Further, the system 100 may include a wearable device 102, a conducting medium 106, and a receiving device 104. Further, the wearable device 102 may be configured to transmit and receive electro-quasistatic signals (EQSs) carrying data with the receiving device 104.

Further, the conducting medium 106 may be configured to carry the EQS signals from the wearable device 102 to one or more surrounding objects 112 using a human body communication network. Further, the conducting medium 106 may be a human body. Further, the conducting medium 106 may be used for transferring the EQS signal from the one or more wearable devices 102 to the one or more receiving devices 104. Further, the one or more surrounding objects 112 augmented with conducting parts 110 to enable application-specific interaction with the wearable device 102. Further, the one or more surrounding objects 112 are in proximity with the conductive medium 106 and the conducting parts 110 are configured to forward the EQS signals from the conducting medium 106 to the receiving device 104. Further, the EQS signals are modulated using modulation schemes such as, but not limited to, amplitude modulation (AM), frequency modulation (FM), phase shift keying (PSK), and the like. Further, the EQS signals may be transmitted using one of a multiple-input multiple-output (MIMO) antenna system, a beamforming technique, a power control technique, and a channel coding technique. Further, the EQS signal may be transmitted using techniques, such as, but not limited to, a power management technique, a frequency hopping technique, a time division multiple access (TDMA) technique, a code division multiple access (CDMA) technique, and the like.

Further, the conducting parts 110 may be shaped to optimize coupling of the EQS signals to the conducting medium 106 and the receiving device 104. Further, the conducting parts 110 may be shaped depending upon the intended locations of maximizing the received signal strength and the shape of the augmented surrounding objects 112. Further, the shape of the surrounding objects 112 may include, but not limited to, a narrow width square conducting frame attached to the edges of a long square-shaped table for information exchange around the table, and the like.

Further, the conducting parts 110 may be configured to guide the EQS signals through the one or more surrounding objects 112 to facilitate energy-efficient, low-loss communication paths for on-body-to-off-body data transfer. Further, the conducting parts 110 may be configured to specific designs. Further, the specific designs may include specifically positioned sharp corners with lower radii of curvature (Rc) to increase surface charge density and electric field strength. Further, The conducting parts 110 are sized to provide a desired communication range between the wearable device 102 and the receiving device 104. Further, the size of the conducting parts 110 may be sufficiently long, but not limited to, extending beyond 2 meter or more Further, the conducting parts 110 may be configured with reduced structure-to-ground coupling capacitance to optimize received signal strength and minimize channel attenuation. Further, the conducting parts 110 of the one or more surrounding objects 112 may be designed with application-specific patterns to maximize the channel gain. Further, the application specific patterns may include, but not limited to, a square shaped conducting part 110 attached to the frame of a square-shaped table, a cross-shaped conducting part 110 attached to a table for communication to intended recipients sitting at the corners of the table, and the like.

Further, the conducting parts 110 may be intended at communication locations based on touch-based events. Further, the communication locations may include, but not limited to, a conference room, any location where wearable devices 102 and receiving devices 104 are in a close proximity, and the like. Further, the conducting parts 110 may be used in conjunction with a wireless power transfer system to enable wireless charging of wearable devices 102. Further, the wireless charging of battery-operated portable or wearable devices 102 may be achieved by coupling the conducting parts 110 of surrounding objects 112 to a power transmitter, or to a wall-connected transmitter with higher power transferring capacity. Further, the wearable devices 102 such as, but not limited to, smartwatches, earbuds, headsets, smart glasses, or portables like tablets and laptops on a touch-sensitive interactive surface with conducting parts 110 for EQS may be capacitively coupled for wireless power transfer. Additionally, wearable devices 102 may be wirelessly powered by touching the augmented surfaces without needing to remove them from the body.

Further, a communication link may be established between the wearable device 102 and the conducting parts 110 of the surrounding objects 112. Further, the communication link may be based on EQS Body Coupled Communication network. Further, the communication link may be configured to ensure non-radiative signal confinement around a human body and the conducting parts 110 of the one or more surrounding objects 112. Further, the non-radiative signal confinement around a human body and the conducting parts 110 of the one or more surrounding objects 112 may be achieved by a communication link. Further, the communication link may be configured to operate with a predetermined carrier frequency (fc) in EQS communication. Further, the predetermined carrier frequency (fc) may be less than or equal to 10 MHz. Further, the resulting communication may be governed by the near field (i.e., capacitively coupled) component of the induced electric field. Further, to make the communication link non-radiative the upper limit on the carrier frequency (fc) to operate in the EQS communication may depend on length of the communication channel. Further, the operating wavelength may remain at least ten times or more than the communication channel length to make the communication link non-radiative.

Further, the communication link may be configured to support data transfer at speeds of up to mbps between the wearable device 102 and the one or more surrounding objects 112 over a frequency range from hundreds of kHz to 20 MHz or more. Further, the communication link enables coverage beyond dimensions of the conducting 106, extending up to 2 meters or more to enable interaction with any of the of a portable and earth-grounded ambient technologies. Further, the portable ambient technologies may include, but not limited to, smartphones, tablets, laptops, or any other battery-operated touchscreen interfaces that offer an interactive environment for users. Further, the earth-grounded ambient technologies may include, but not limited to, Personal computers (PCs), televisions, air conditioners, and other wall-connected electronic home appliances, including touchscreen kiosks at marketplaces for user interaction and payment purposes, and the like.

Further, the receiving device 104 may be configured to receive the EQS signals from the wearable device 102 via the conducting medium 106 and the one or more surrounding objects 112. Further the EQS signal may be received at the receiving device 104 to enable an application-specific interaction. The shape and material properties of the conducting parts 110 may be selected to optimize channel gain. Further, the shape of the conducting parts 110 may be selected depending upon the intended locations of maximizing the received signal strength. Further, the shape of the augmented object may include, but not limited to a narrow width square conducting frame attached to the edges of a square-shaped table for information exchange among the attendees sitting around the table. Further, the material properties of the conducting parts 110 may be determined such that their conductivity must be high so that the narrowest object in the EQS signal path should have low resistance for optimum channel loss.

FIG. 1B illustrates a schematic diagram representation of an exemplary communication system 100 for augmenting human-object interaction in Electro-Quasistatic (EQS), in accordance with another embodiment of the present disclosure. Further, the system 100 may include a one or more wearable devices 102-1, . . . , 102-N (hereinafter referred as wearable device 102), a one or more receiving devices 104-1, . . . , 104-N (hereinafter referred as receiving device 104), a conducting medium 106, one or more conducting parts 110. Further, the one or more wearable device 102 and the one or more receiving device 104 may be configured to transmit and receive a data via a conducting medium 106. Further, the one or more wearable device 102 may include a transmitter and a receiver (not shown) coupled to the conducting medium 106 via Human Body Communication (HBC) network. Further, wearable device 102 may be configured to transmit and receive electro-quasistatic signals (EQSs) carrying data with the receiving devices 104.

Further, the conducting medium 106 may be configured to carry the EQS signals from the wearable device 102 to one or more surrounding objects (not shown) using a human body communication network. Further, the one or more surrounding objects 112 augmented with conducting parts 110 to enable application-specific interaction with the wearable device 102. Further, the one or more surrounding objects 112 are in proximity with the conducting medium 106. Further, the conducting parts 110 may be are configured to forward the EQS signals from the conducting medium 106 to the receiving device 104. Further, the conducting parts 110 may be shaped to optimize coupling of the EQS signals to the conducting medium 106 and the receiving device 104. Further, the conducting parts 110 may be configured to guide the EQS signals through the one or more surrounding objects 112 to facilitate energy-efficient, low-loss communication paths for on-body-to-off-body data transfer. Further, the conducting parts 110 may be configured to specific designs. The design may include specifically positioned sharp corners with lower radii of curvature (Rc) to increase surface charge density and electric field strength. Further, the examples of specific design modifications may include adding conducting parts 110 at the edges or corners of the frames of surrounding objects 112. Further, the frames of the surrounding objects 112 may include, but not limited to, the frame of general-purpose touchscreen interfaces at marketplaces, personal devices like smartphones, augmenting objects like tables, chairs in conference rooms, car chassis, hospital beds, and the like.

Furthermore, the conducting medium 106 may be coupled to a network 114. Further, the network 114 may be configured to work as the infrastructure that allows communication systems 100 to connect and exchange information. Further, the network 114 may be configured to establish a connection between the wearable devices 102, the receiving devices 104, and the conducting medium 106 for enabling seamless communication regardless of their physical location. Furthermore, the communication system 100 may be communicatively coupled to a server 116. The server 116 may be configured to function as an intermediary, facilitating the seamless flow of information between the wearable devices 102, the receiving devices 104, and the conducting medium 106.

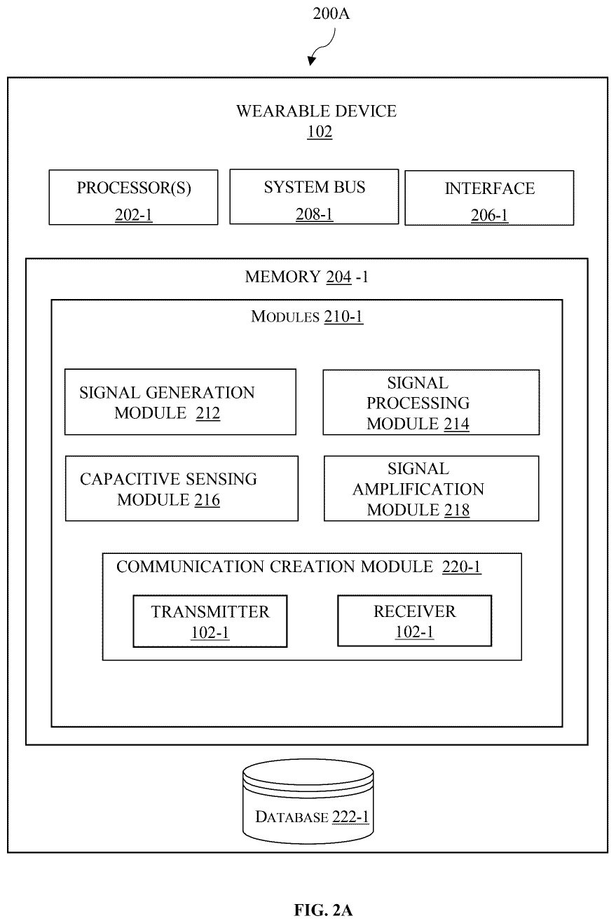

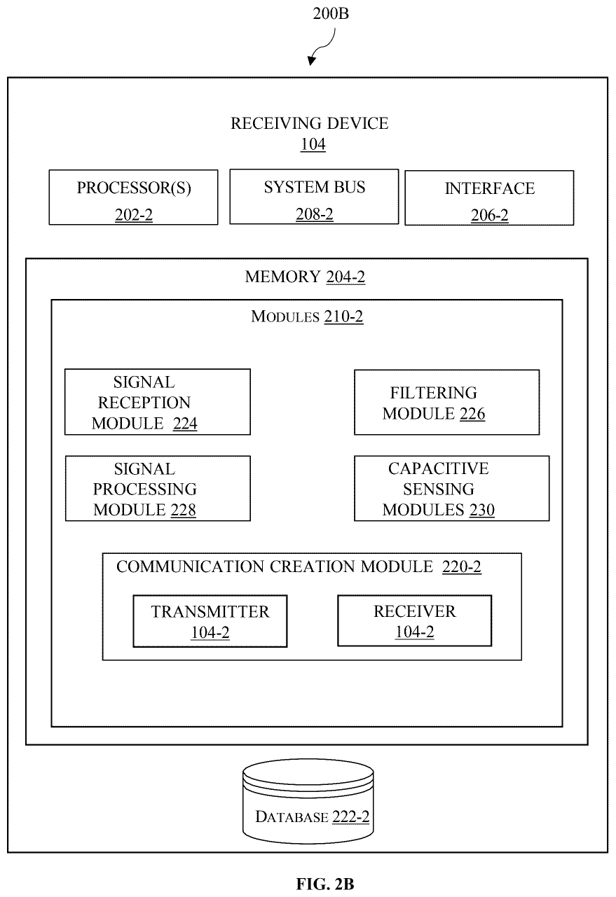

FIG. 2A illustrates a block diagram representation of an exemplary wearable device 102 for augmenting human-object interaction in EQS, in accordance with an embodiment of the present disclosure. Further, the wearable device 102 may include a processor 202-1, a memory 204-1 coupled to the processor 202-1. Further, the memory 204-1 may include processor-executable instructions in the form of one or more modules 210-1. Further, the one or more modules 210-1 may include modules such as, but not limited to, a signal generation module 212, a signal processing module 214, a capacitive sensing module 216, a signal amplification module 218, a communication creation module 220-1.

Further, the signal generation module 212 may be configured to produce the low-frequency electric signals required for EQS communication. The EQS signal may operate in the quasistatic regime, the frequency of the signals may be typically low, often in the range of hundreds of kHz to 20 MHz. Further, the signal generation module 212 may include a signal source, such as a voltage-controlled oscillator (VCO) or digital signal generator, which generates controlled, precise electric potentials. The signals drive the interaction between the human body and external conducting parts 110 through capacitive coupling. Further, the signal processing module 214 may be configured to process the transmitted and received EQS signals. Further, the signal processing module 214 may include filtering and modulation techniques for refining the signals, removing unwanted noise, and preparing signals for interpretation. Further, Digital signal processors (DSPs) may be used to analyze the signal characteristics and extract useful data from the interactions, such as changes in body position or touch events on the conducting structure. Further, the signal characteristics may include, but not limited to, amplitude, frequency, phase, bandwidth, signal-to-noise ratio, modulation, and the like. Further, after filtering and demodulation, the received signal characteristics may be analyzed via digital signal processors to observe the variability in the communication channel of interest under different scenarios of user interactions with augmented surrounding objects 112. Further, the capacitive sensing module 216 may be configured to monitor the changes in capacitance between the wearable device 102 and the conducting part 110 (or another human body). Further, the capacitive sensing module 216 may measure the variations in the electric field to detect interactions, such as physical contact or proximity as the EQS systems rely on capacitive coupling. Further, the changes are analyzed to interpret user inputs or communication signals.

Further, the signal amplification module 218 may configured to ensure that the generated EQS signals are strong enough to be transmitted through the conducting medium 106 and detected at the receiving device 104. Further, the signal amplification module 218 may include a low-noise amplifier (LNAs) to boost the signal strength without introducing significant noise, ensuring reliable signal propagation across the body-to-structure interface.

Further, the communication creation module 220-1 may be configured to establish the broadband communication channel with the wearable device 102 based on the EQS signal. Further, the communication creation module 220-1 may be configured to transfer data as the EM signals from the wearable device 102 to the receiving device 104.

FIG. 2B illustrates an exemplary block diagram representation of a receiving device 104 for augmenting human-object interaction in EQS, in accordance with an embodiment of the present disclosure. Further, the receiving device 104 may include a processor 202-2, a memory 204-2 coupled to the processor 202-2. The memory 204-2 may include processor-executable instructions in the form of one or more modules 210-2. Further, the one or more modules 210-2 may include modules such as, but not limited to, a signal reception module 224, a filtering module 226, a signal processing module 228, a capacitive sensing module 230, a communication creation module 220-2.

Further, the signal reception module 224 may be configured to capture the low-frequency EQS signals transmitted through the human body or a conducting structure. Further, the signal reception module 224 may typically include a receiving electrode or capacitive plate that comes in contact with or remains in close proximity to the conducting part 110 or body. Further, the signal reception module 224 may detect small changes in the electric field and transforms these variations into electrical signals, enabling communication between the transmitter 102 and the receiving device 104.

Further, the filtering module 226 may be configured to isolate the desired EQS signal frequencies from any external noise or interference. Further, the filtering module 226 may typically include bandpass filters to allow specific low-frequency ranges to pass through while rejecting high-frequency noise, ensuring the received signal is clean and ready for further analysis. Further, the high-frequency noise and interferences may be filtered out from the received signal for reliable digital communication.

Further, the signal processing module 228 may be configured to interpret the received data. The signal processing module 228 may include digital signal processing (DSP) algorithms that demodulate, decode, and extract the relevant information from the EQS signal. Further, the signal processing module 228 may be configured to analyze user interactions, detect touch events, or interpret communication data transmitted from the wearable device 102.

Further, the capacitive sensing module 230 may be configured to monitor the changes in capacitance between the receiving electrode and the environment. Further, the change in the level of received signal may be observed by monitoring the changes in the involved capacitances by principle of operation of voltage mode capacitive-coupling based body coupled communication. Further, the receiving device 104 may detect shifts in the electric field caused by user interactions, proximity, or other influences, allowing for responsive and real-time data collection by measuring the change in capacitance. Further, the capacitive-coupling based body coupled communication principle may involve quasistatic near-field, capacitive coupling-based interactions. Further, the variation in proximity of user to the conducting parts 110 of the surrounding structures 112 changes the induced electric field, resulting in variability of the recorded received voltage at the receiving devices 104 communicatively coupled to the augmented surrounding structures 112.

Further, the communication creation module 220-2 may be configured to establish the broadband communication channel with the receiving device 104 based on the EQS signal. Further, the communication creation module 220-2 may be configured to transfer data from the receiving device 104 to the wearable device 102.

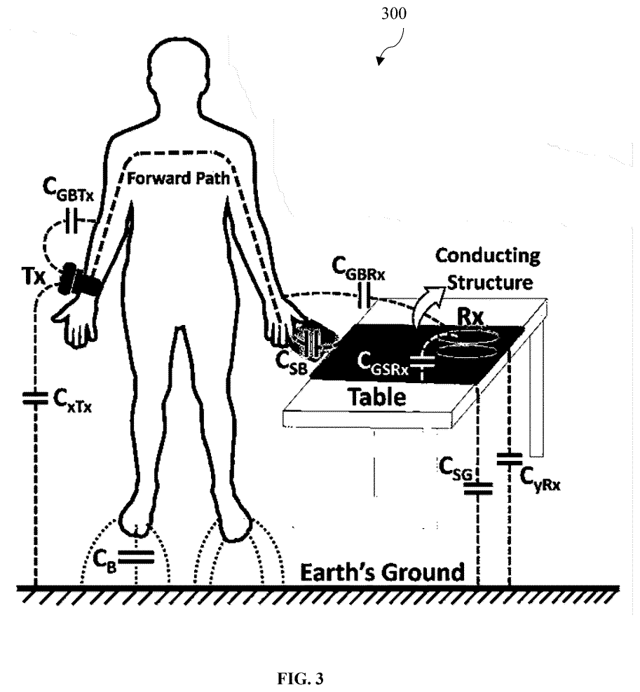

FIG. 3 illustrates an exemplary schematic diagram representation of a human body interacting with a conducting part 110 in EQS, in accordance with an embodiment of the present disclosure. According to FIG. 33, Human-Structure Interaction (HSI) (also referred as human object interaction, interchangeably) in EQS and captures the associated capacitive couplings. An energy-efficient communication between a human and an off-body augmented object, a structure of high enough electrical conductivity (i.e., electrical conductivity (σ) comparable to metals or such that the narrowest object in the signal path should have low enough resistance for optimum channel gain) between the communicating objects is introduced to ensure the guided nature of the coupled EQS-field by enabling the forward path of signal transmission through the body and the conducting strips (also referred herein as conducting parts 110). The communication channel established is a higher link margin via a non-radiative and a guided mode of communication and offering specificity via touch-based events facilitates the EQS Human Structure Interaction (HSI).

According to FIG. 3, a human body interacting with a conducting part 110 in EQS may include a capacitance between the conducting medium 106 and the wearable device 102 (CGBTx), a capacitance between the receiving device 104 and the ground structure (CGSRx), a capacitance between the receiver's ground and the human body (CGBRx), a capacitance between the table surface and the human body (CSB), a capacitance of the wearable device 102 relative to the ground (CxTx), a capacitance between the receiving device 104 and the Earth ground (CSG), a capacitance of the human body to the ground (CB), and the like. Further, the system may be designed for capacitive human body communication (HBC), where electrical signals are sent through the human body using the body's natural conductive properties and external capacitive couplings to nearby surfaces and the ground.

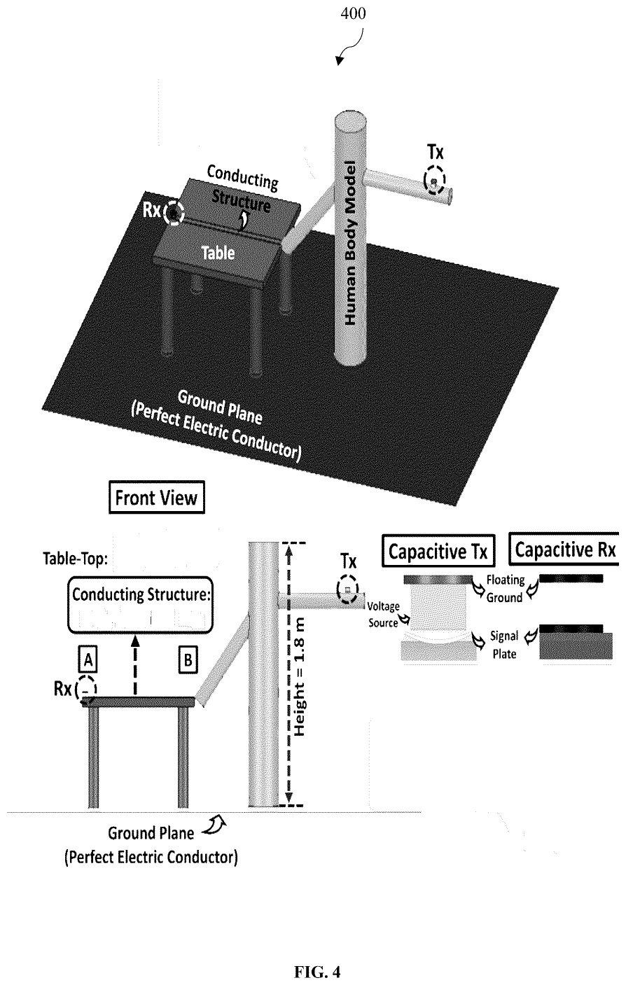

FIG. 4 illustrates an exemplary schematic diagram representation of a Finite Element Method (FEM)-based setup for numerical simulation of human-object interaction in EQS, in an accordance with an embodiment of the present disclosure. Further, the setup may include, a human body model, and a conducting part 110. Further, the human body model may include cylindrical shape representing a simplified human body with specific dimensions for the muscle and skin. Further, a transmitter may be couped to an arm of the human body model. Further, the transmitter may transmit the signal. Further, a table may act as a supporting structure (or surrounding object 112) with a conducting plate, (or a conducting part 110) providing a ground reference and signal coupling. Further, a table top may include a conducting parts 110 which aids in signal reception by interacting with the human body (conducting medium 106) and a receiving device 104. Further, the receiving device 104 may be Positioned on the table. Further, the receiving device 104 may be configured to collect the signal transmitted from the human body (conducting medium 106). Further, the entire setup may be placed on a ground plane, acting as an electrical conductor that facilitates the return path for the signal and allows capacitive coupling with the surrounding objects 112. Further, the table with conducting parts 110 may be attached to surrounding objects 112, expanding the potential applications involving human-machine interactions. Further, the wearable devices 102 may be linked to the user and surrounding structures detect the presence of the conducting medium 110 and facilitate information transfer by guiding EQS signals through the conducting medium 106 and existing conducting parts 110.

Further, the setup may include a capacitive transmitter. Further, the capacitive transmitter may include capacitive coupling mechanism from the human body through the signal plate and a floating ground. Further, the signal plate and floating ground form the capacitance used for the transmission of the signal through the human body. Further, the setup may include a capacitive receiver. Further, the receiver may include a signal plate and ground plate to capture the signal capacitively. Further, transmitter may be coupled to the human body model. Further, the human body may act as a medium for communication. Further, the signal may be coupled capacitively between the human body, the conductive structure, and the ground.

The user wears a wearable transmitter 108 associated with the wearable device 102 on one arm, while the other arm makes contact with the conducting part 110 mounted on a wooden table. The receiving device 104 is attached to the conducting part 110, with a signal plate in direct contact with the conducting parts 110. Further, the receiver's ground remains floating (not connected to a specific reference point). Further, The system 100 utilizes the body as part of the communication path, leveraging the conducting properties of the human body and the conducting part 110 to facilitate signal transmission.

Further, the conducting part 110 improves the end-to-end channel gain during touch-based interaction. The channel gain characteristic may be evaluated using Finite Element Method (FEM)-based Electro-Magnetic (EM) simulation, which captures the electromagnetic field distribution and behavior between the wearable device 102, the conducting medium 106, and the conducting part 110, which together form a unique communication channel. The simulation focuses on the interactions between the capacitive and the resistive properties of the body and the conducting part 110. The results from the FEM-based EM simulation provide a channel gain which varies across the setup. One or more parameters influencing the channel gain includes, but not limited to the contact quality between the user hand and the conducting part 110. Further, the simulation provides signal strength which is influenced by the conductive paths created through the conducting medium 106 and the conducting part 110.

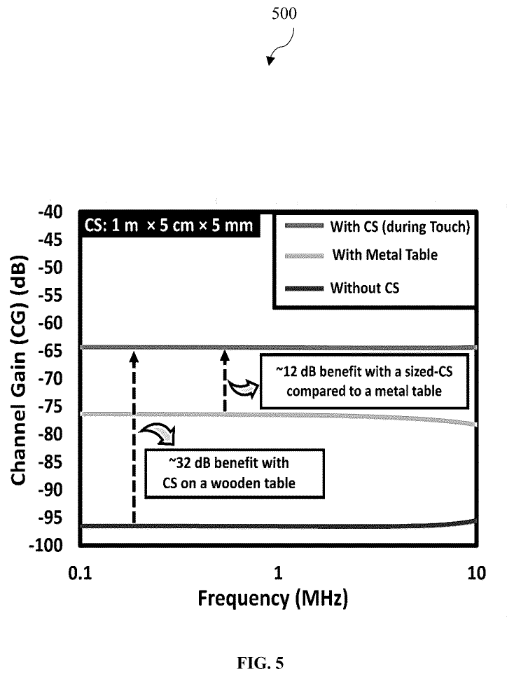

FIG. 5 illustrates an exemplary graphical representation of human-object interaction channel characteristics during presence of conducting part 110, in accordance with an embodiment of the present disclosure. The end-to-end channel gain during touch-based interaction improves by ˜32 dB (˜40× improvement in received voltage) with the sized conducting strip. By replacing the table material with copper, the channel gain attenuates by ˜12 dB compared to the scenario when one conducting strip is present on a wooden table. Hence, suitable sizing (dimension) of the conducting parts 110 that are to be augmented to the surrounding object is a critical parameter in optimizing the channel gain.

Further, the graph illustrates the channel gain (CG) for a human-surface interaction (HSI) communication system. Further, the graph includes three curves such as, but not limited to curve for scenario where no conducting part 110 is used, curve for scenario which uses a metal table as part of the grounding structure, curve for scenario uses a properly sized conducting part 110 during physical touch between the human and the structure. The 32 dB Benefit with conducting part on a Wooden Table is observed when a sized conductive structure is used on a wooden table (a non-conductive surface), the improvement in signal gain is approximately 32 dB compared to the “Without CS” case. Further, the graph also shows that using the sized conducting part 110provides a 12 dB improvement over a metal table. Further, the channel gain remains relatively consistent across the frequency range, indicating that the benefit of using a conducting part 110 is relatively stable from 0.1 MHz to 10 MHz.

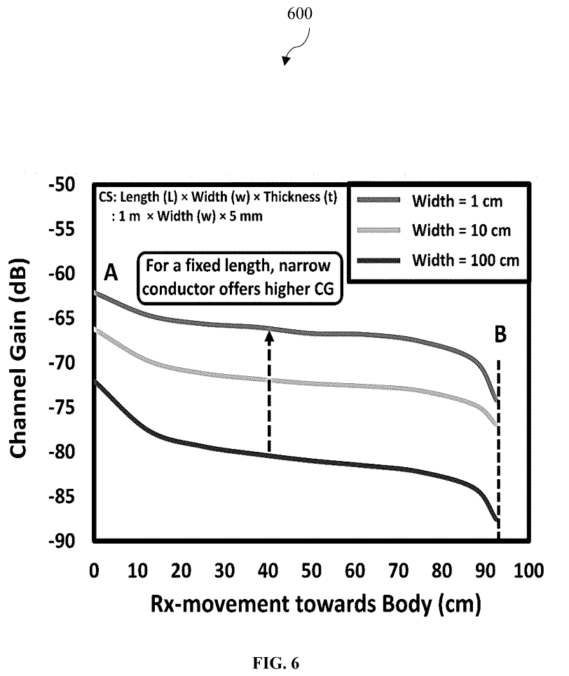

FIG. 6 illustrates an exemplary graphical representation of the variability in channel gain characteristics with the width variation of the incorporated conducting part 110 during touch-based interactions, in accordance with an embodiment of the present disclosure. In order to optimize the received signal strength, evaluating the size/dimension of the conducting part 110 on the augmented objects is essential. For a fixed-length communication channel, a 100× reduction in width of conducting part leads to ˜12 dB improvement in received voltage at position B (i.e., at a location 5 cm away from the body) and ˜18 dB at position A (i.e., at location 95 cm away from the body), shown in FIG. 6 i.e., a narrow but long enough conductor offers higher link margin. Thus, designing the conducting parts 110 with reduced structure-to-ground coupling capacitance (C_{SG}) is necessary. The rise in voltage gain with a narrow conductor may be attributed to the reduction in C_{SG}, coupling between receiver ground and structure (C_{GSRx}), and an increase in return path capacitance (C_{yRx}) at the receiver. The channel gain may decrease as the receiver gradually starts moving from the side of the table towards the human body which happens due to an increase in the capacitive coupling between the floating ground of the receiver and the human body (C_{GBRX}) at reduced distance (near location B) and termed as body-shadowing previously. Further, the attenuation in channel gains from the higher body shadowing may be addressed by changing the orientation of the receiver ground, which reduces C_{GBRx} and increases the receiver's return path capacitance (C_{yRx}). Further, a narrowest conducting part 110 may provide the highest channel gain (around −65 dB at point A), especially when the receiver is at distances of around 40 cm from the body. As the width of the conducting part 110 increases, the channel gain decreases. The 100 cm wide conductor shows the lowest gain, around −80 dB, indicating that wider conductors are less effective for signal transmission in the setup.

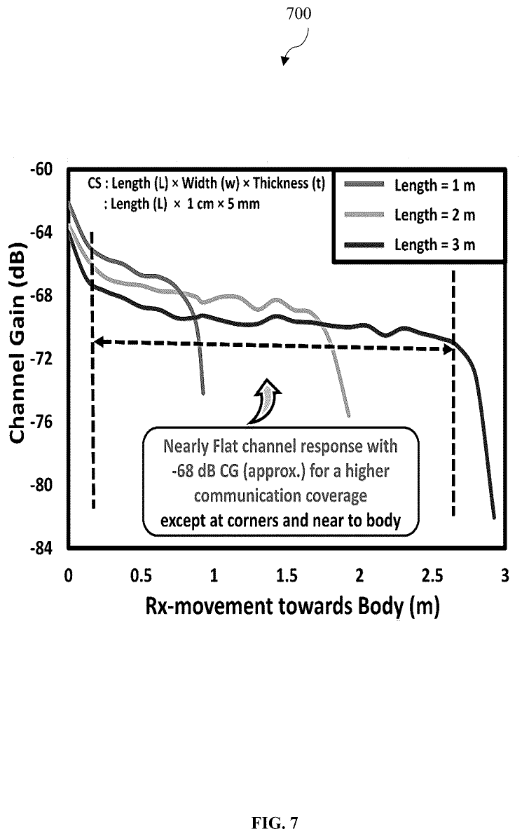

FIG. 7 illustrates an exemplary graphical representation of the channel gain dependency on the variation in the length of the conducting part 110, in an accordance with an embodiment of the present disclosure. The graphical representation includes the channel gain on the y-axis and the length of the conducting part 110 on the x-axis. The X-axis represents the length of the conducting part 110 (in meters, for example), ranging from short lengths to longer ones. The Y-axis represents the channel gain (in decibels, dB), typically from 0 dB (maximum gain) down to negative values (indicating attenuation), such as −68 dB. As the length of the conducting part 110 increases, the channel gain curve stays nearly flat in the midway of the CS. Further, the flat response indicates the channel gain is relatively constant except near the end of the table and close to the body, and the system maintains reliable communication across various lengths of the CS. Further, the channel gain value is approximately −68 dB, indicating the signal is being attenuated, however in a consistent manner, providing higher communication coverage.

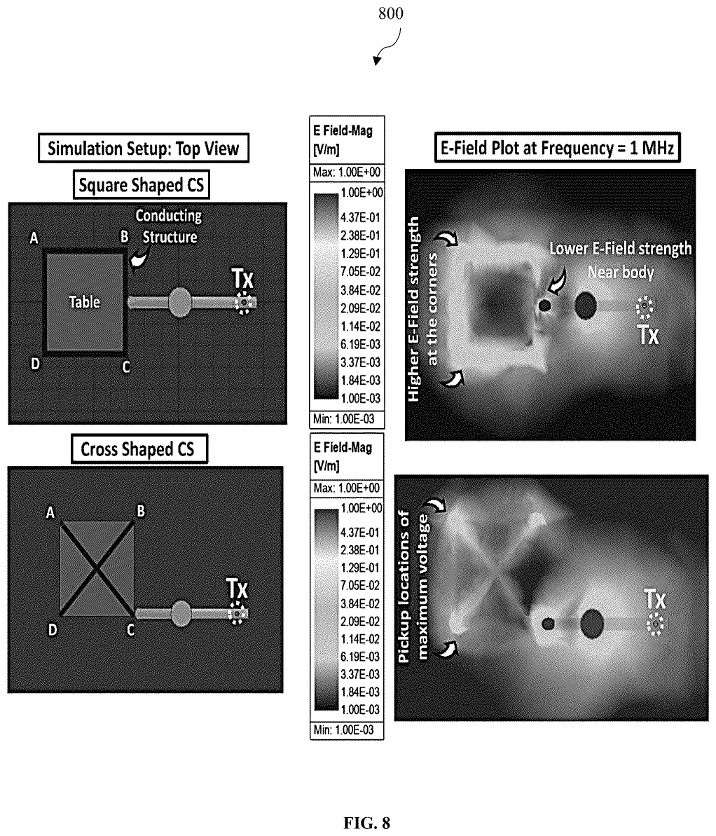

FIG. 8 illustrates an exemplary schematic diagram representation of the dependency of channel specificity on application-specific patterning of the incorporated conducting structure, in accordance with an embodiment of the present disclosure. The application-specific patterning of the conducting parts 110 of the augmented objects is important to offer specificity in communication while guiding EQS signals at the intended locations. Further, designing an optimal shape for the conducting parts 110 may facilitate in maximizing the channel gain. Further, the locations of sharp corners in the conducting part with a lower radius of curvature (R_{c}) have higher surface charge density (i.e., surface charge density (σ) α1/R_{c}), which results in higher electric field strength. Further, the conducting part is patterned to be an intended shape with sharp corners at the intended locations, the maximum voltage may be picked up by optimally positioning the receiver ground plane relative to the conducting part and the user body, which may be visualized via the E-field plot. According to FIG. 8, simulation shows a square-shaped conducting part 110 around a table. Points A, B, C, and D mark the corners of the square, and the transmitter (Tx) is placed to the right of the table, connected via a straight line. Further, the simulation shows a cross-shaped conducting structure, with diagonal conductors connecting the opposite corners of the square. The points A, B, C, and D remain at the same locations as in the square-shaped CS, with the transmitter (Tx) in the same position as before. Further, the E-field strength is highest at the corners of the square-shaped structure (points A, B, C, and D). Further, the E-field strength is lower near the body and areas around the table where the conducting part 110 is present. Further, the cross-shaped structure results in higher E-field strength along the diagonal conductors and in areas where the diagonals meet the perimeter. Further, the cross design creates a more even and stronger distribution of E-field across certain areas, especially at the intersections of the cross and the perimeter. Further, better communication coverage may be achieved, compared to the square setup, particularly at the pick-up locations where maximum voltage is found.

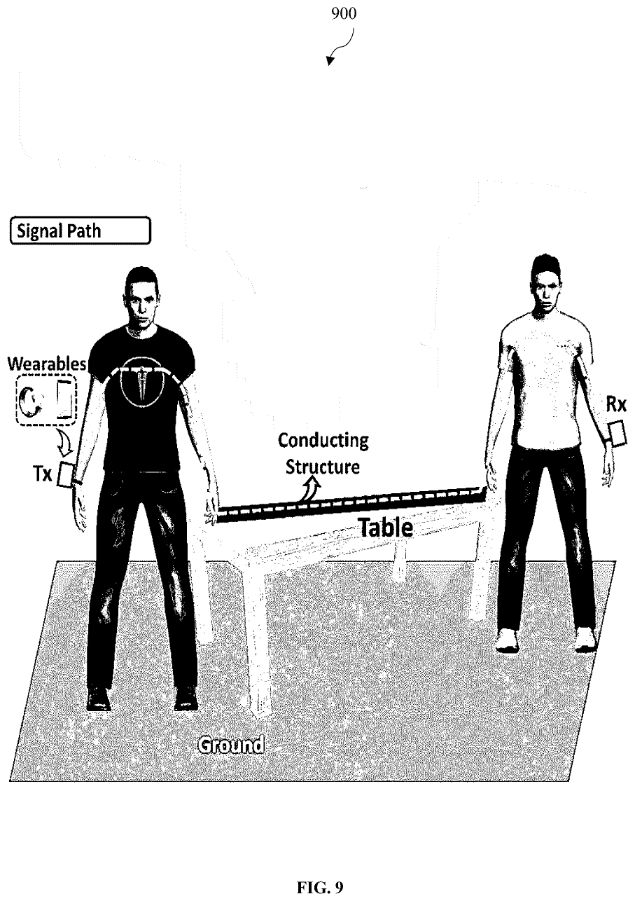

FIG. 9 illustrates a schematic diagram representation of non-radiative interactions between one or more human body via conducting structures by enabling Human-Structure-Human Interaction (HSHI) in EQS, in an accordance with an embodiment of the present disclosure. The non-radiative communication relies on the capacitive coupling between different components, including the human body and the conducting medium, or between two human bodies in proximity. The components form a system of capacitors, with each body or conducting surface acting as one plate of the capacitor, and the space or dielectric medium between them (e.g., air, skin) acting as the insulating layer.

Further, the Human-Structure-Human Interaction (HSHI) refers to a system where two or more humans interact with conducting parts 110 enabling communication or signal transfer between two human bodies. Further, suggests that two human bodies (Tx=Transmitter and Rx=Receiver) may communicate by physically touching a shared conducting part 110 such as, but not limited to a table. Further, a Signal Path may be represented as a dashed line connecting a wearable device 102 on the first person (Tx) to the conducting part 110 such as, but not limited to a table, which then connects to the other person (Rx) with a receiving device 104 depicting signal or data flow through a physical structure via human touch. Further, according to FIG. 9, illustration of a system where two people, wearing devices (wearable device 102 and receiving device 104), may communicate or interact through a conducting part 110 in an EQS environment, enabling touch-based communication without the need for wireless pairing.

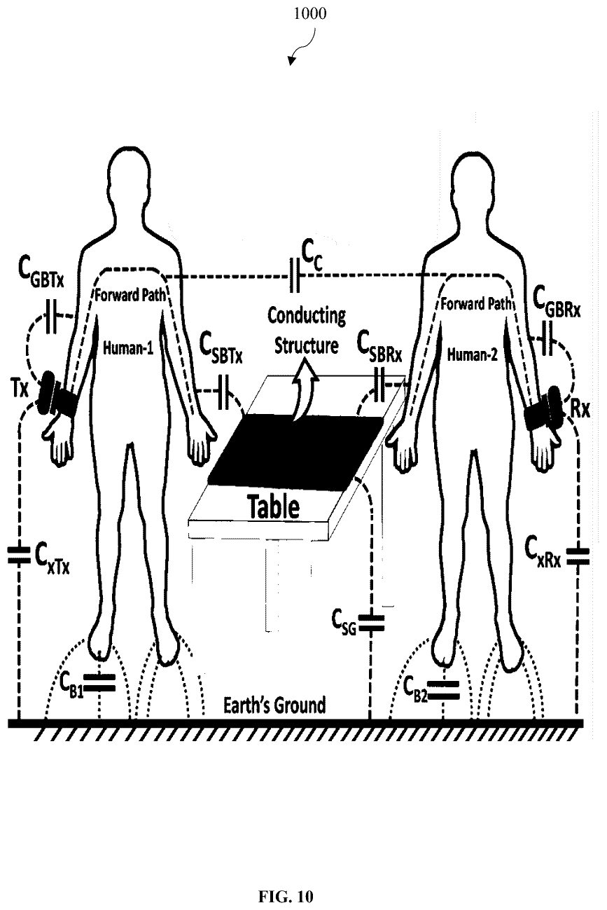

FIG. 10 illustrates a schematic diagram representation of a circuitry of Human-Structure-Human Interaction (HSHI) in EQS, in an accordance with an embodiment of the present disclosure. Further, the communication and interaction may occur through capacitive coupling between the human body, the structure (such as a conducting surface or object), and another human body. Further, the form of interaction leverages the electrical properties of the human body and the conducting part 110 to enable signal transmission and interaction. Further, the capacitive coupling forms communication channels through the intrinsic ability of the human body's to store and transmit electrical charges. Further, the interbody coupling refers to interaction between two human bodies, facilitated by close proximity or physical touch, allowing signal transfer between the two participants. The Body-Structure Coupling may refer to the interaction between a human body and a conducting parts 110, where the body acts as one plate of a capacitor and the conducting part 110 as the other, creating a pathway for signal transmission.

Further, the capacitance between the body and the conducting parts 110 (C_body-CS) may be formed when a human touches the conducting part 110, and a body-structure capacitance (C_body-CS) that is denoted as C_{SB} in the Figures is established. The electric field generated enables signal exchange, forming the foundation of the communication circuit. Further, as an example, when the human touches the conducting parts 110, a capacitive link is formed, allowing signal transmission between the human and the conducting parts 110. Further, the transmission may allow efficient communication between the body and external objects, with the signal travelling through both the body and the structure. Further, as an example where two human bodies interact (e.g., holding hands or standing in close proximity), a capacitive coupling is created between both the human bodies. Further, the capacitive coupling may form an interbody capacitance (C_body-body) to enable signal transfer between the two human bodies. Further, a wearable device 102 on one arm may be configured to transmit a signal through the body. Further, the transmitted signal may be received by a receiving device 104 placed on the other arm of the another human body.

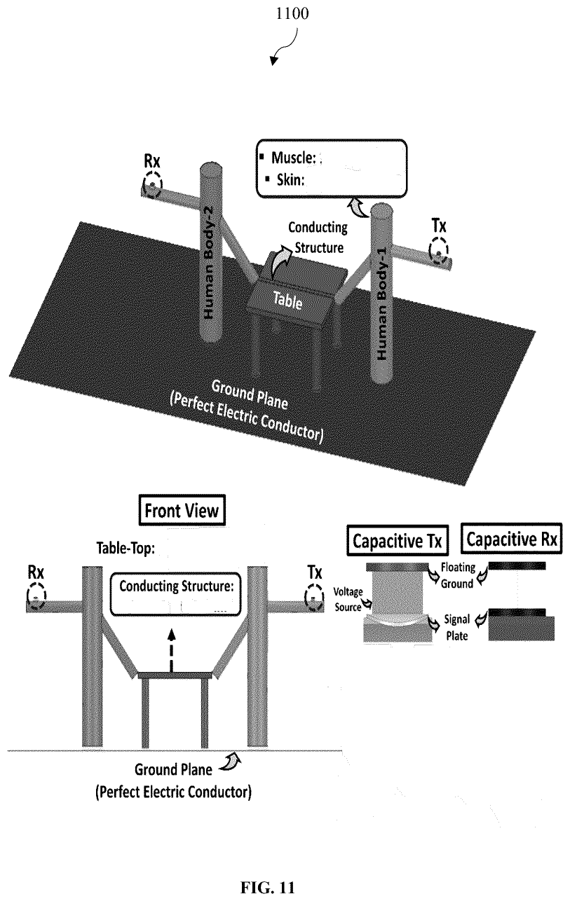

FIG. 11 illustrates a schematic diagram representation of a Finite Element Method (FEM)-based setup for numerical simulation of Human-Structure-Human Interaction (HSHI) in EQS, in accordance with an embodiment of the present disclosure. The FEM simulation analyzes and provides the electric field distribution, capacitive coupling, and signal transmission characteristics between two human bodies interacting through a conducting part 110 in the EQS. Further, the system uses two human models and conducting elements to simulate realistic body interaction, focusing on how capacitance changes in the presence of the human body, ground plane, and table setup. Additionally, a finite element-based electromagnetic solver, utilizing the finite element method (FEM), may be employed to analyze the behavior of electromagnetic (EM) fields across the frequency range of interest. Further, the human models my include, but not limited to, Visible Human Project (VHP), Harmonized Anatomical Model (HANNAH), and the like. Further, the numerical simulations may be performed using engineering simulation software such as, but not limited to, High-Frequency Structure Simulator (HFSS) from Ansys, and the like. Further, a simplified cross-cylindrical human body model, with tissue properties adapted from the Gabriel database may be used. Further, the accuracy of model is verified by comparing the electromagnetic field and current distribution with human models such as, but not limited to, a detailed Visible Human Project (VHP) female model available from NEVA EM, and the like.

Further, two human figures are labelled as Human Body-1 and Human Body-2. Further, each of the human bodies has a Tx (Transmitter) and Rx (Receiver) near their arms, indicating these are likely acting as capacitive electrodes involved in transmitting and receiving signals. Further, the muscle and skin dimensions of the human model may include, but not limited to, muscle dimension of a 13.6 cm radius and the skin dimension of a 4 mm thickness, and the like.

Further, the Tx and Rx may be capacitively coupled devices. Further, the Tx may be connected to a Voltage Source and has a Signal Plate. Further, there may be a floating ground below the signal plate for both the Tx and Rx, used to isolate the signal. Further, the dimensions of the signal plates and ground plates for both the transmitter and receiver may vary. Further, the signal Plate and Ground Plate radius, thickness, and patch size may be provided in variable dimensions.

Further, according to FIG. 11, the human model setup may investigate signal transmission via capacitive coupling between two human bodies across a conductive structure (table) with a controlled ground plane to study human body communication, near-field communication systems, or bio-electrical interactions in the presence of conductive materials.

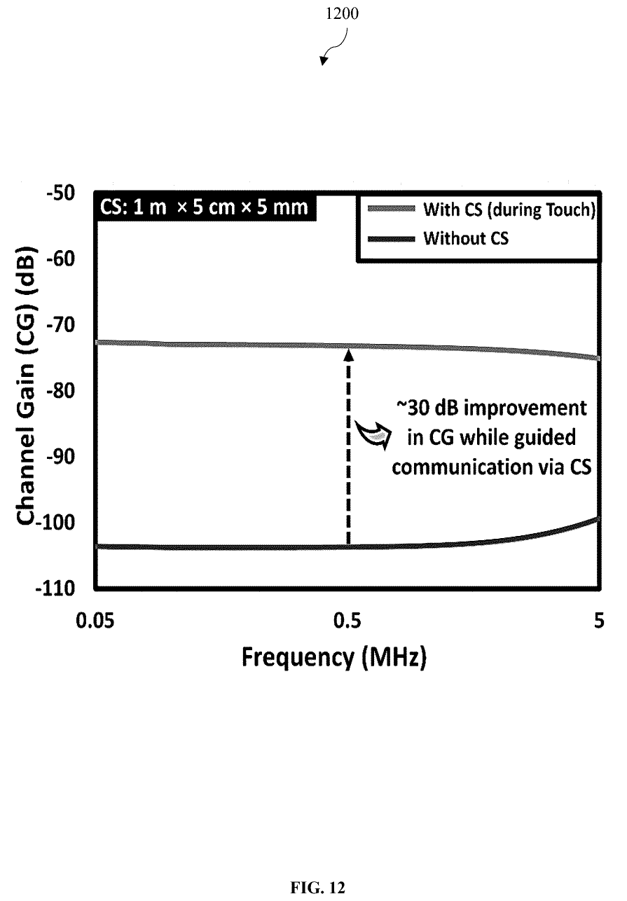

FIG. 12 illustrates a graphical diagram representation of the presence of the conducting part 110 on the Human-Structure-Human Interaction (HSHI) channel, in accordance with an embodiment of the present disclosure. In the case of communication between two human bodies in the EQS regime, the inter-body coupling together with the guiding conducting medium decide the channel gain. The conducting part 110 guides the EQS signal to the intended recipients by enhancing the coupled EQS field strength around the subject's body ensures wireline-like benefits via touch-based interactions. Further, the graph shows the channel gain (CG) for two different scenarios such as, but not limited to, with and without a conducting part 110. Further, in the presence of the conducting part 110, the channel gain is higher (around 30 dB improvement) compared to the case without the conducting part 110. This improvement is particularly noticeable at higher frequencies. Further, the graph also depicts the effect of touch on the channel gain when the conducting part 110 is present. Further, the solid line represents the channel gain during touch, while the dashed line represents the channel gain without touch. The touch seems to have a minor impact on the channel gain.

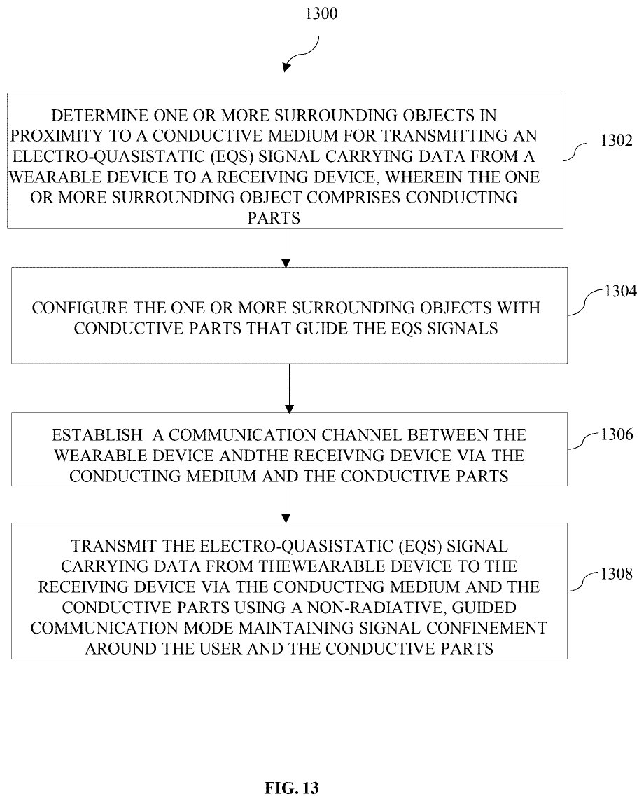

FIG. 13 illustrates a process flow diagram representation of a method 1300 for augmenting human-object interaction, in accordance with an embodiment of the present disclosure. As illustrated in FIG. 13, the following steps may be implemented.

At step 1302, the method 1300 includes determining, by a processor 202, one or more surrounding objects in proximity to a conductive medium for transmitting an electro-quasistatic (EQS) signal carrying data from a wearable device 102 to a receiving device 104. The one or more surrounding object 112 may include conducting parts 110. At step 1304, the method 1300 includes configuring, by the processor 202, the one or more surrounding objects 112 with conducting parts 110 that guide the EQS signals. Further, the wearable devices 102 and the receiving devices 104 may be configured to sense the change in capacitance from the proximity of the surrounding objects 112 and to drive the EQS signal through the conducting parts 110 of the surrounding objects 112 to enable human structure interactions. At step 1306, the method 1300 includes establishing, by the processor 202, a communication channel between the wearable device 102 and the receiving device 104 via the conducting medium 106 and the conducting parts 110. At step 1308, the method 1300 includes transmitting, by the processor 202, the electro-quasistatic (EQS) signal carrying data from the wearable device 102 to the receiving device 104 via the conducting medium 106 and the conducting parts 110 using a non-radiative, guided communication mode maintaining signal confinement around the user and the conducting parts 110.

Further, the method 1300 may include routing, by the conducting parts 110, the EQS signal from the conducting parts 110 to the receiving device 104. Further, the method 1300 may include receiving, by the receiving device 104, the EQS signal at the receiving device 104 to enable an application-specific interaction. Further, the method 1300 may include adjusting the size and shape of the conducting parts 110 to minimize coupling capacitance to earth ground. Further, the method 1300 may include applying application-specific patterns to the conducting parts 110 to maximize electric field strength and voltage pickup at intended communication points.

Further, the method 1300 may include establishing interactions between the conducting parts 110 through human structure interactions, comprising at least one of an Inter-Structures Interaction (SSI) and a Human-Structure-Human Interaction (HSHI), using EQS network. Further, the method 1300 may include wirelessly charging wearable devices 102 by using ground-connected or floating-ground electronic devices through the human body. The power transfer enables charging and data communication for devices placed on EQS-augmented surfaces.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having”, “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim

1. A communication system for augmented human-object interaction, comprising:
a wearable device configured to transmit and receive electro-quasistatic signals (EQSs) carrying data with a receiving device;
a conducting medium configured to carry the EQS signals from the wearable device to one or more surrounding objects using a human body communication network;
the one or more surrounding objects augmented with conductive parts to enable application-specific interaction with the wearable device, wherein the one or more surrounding objects are in proximity with the conductive medium and wherein the conductive parts are configured to forward the EQS signals from the conducting medium to the receiving device;
a communication link established between the wearable device and the conductive parts of the surrounding objects, wherein the communication link is based on EQS Body Coupled Communication network, wherein the communication link is configured to ensure non-radiative signal confinement around a human body and the conductive parts of the one or more surrounding objects; and
the receiving device configured to receive the EQS signals from the wearable device via the conducting medium and the one or more surrounding objects.

2. The system of claim 1, wherein the conductive parts are shaped to optimize coupling of the EQS signals to the conducting medium and the receiving device and wherein the conductive parts are configured to guide the EQS signals through the one or more surrounding objects to facilitate energy-efficient, low-loss communication paths for on-body-to-off-body data transfer and wherein the conducting parts are configured to specific designs, wherein the design comprises specifically positioned sharp corners with lower radii of curvature (Rc) to increase surface charge density and electric field strength.

3. The system of claim 1, wherein the conductive parts are sized to provide a desired communication range between the wearable device and the receiving device.

4. The system of claim 1, wherein the communication link supports data transfer at speeds of up to mbps between the wearable device and the one or more surrounding objects over a frequency range from hundreds of kHz to 20 MHz and wherein the communication link enables coverage beyond dimensions of the conductive medium, extending up to 2 meters to enable interaction with one of a portable and earth-grounded ambient technologies.

5. The system of claim 1, wherein the conductive parts are configured with reduced structure-to-ground coupling capacitance to optimize received signal strength and minimize channel attenuation.

6. The system of claim 1, wherein the EQS signals are modulated using a modulation scheme selected from one of amplitude modulation (AM), frequency modulation (FM), and phase shift keying (PSK).

7. The system of claim 1, wherein the EQS signals are transmitted using one of a multiple-input multiple-output (MIMO) antenna system, a beamforming technique, a power control technique, a channel coding technique.

8. The system of claim 1, wherein the conductive parts of the one or more surrounding objects are designed to generate application-specific patterns maximizing channel gain and wherein the conductive parts are at intended communication locations based on touch-based events.

9. The system of claim 1, wherein the EQS signal is transmitted using a power management technique, a frequency hopping technique, a time division multiple access (TDMA) technique, and a code division multiple access (CDMA) technique.

10. The system of claim 1, wherein the EQS signal is received at the receiving device to enable an application-specific interaction, wherein the shape and material properties of the conductive parts are selected to optimize channel gain.

11. The system of claim 1, wherein the conductive parts are used in conjunction with a wireless power transfer system to enable wireless charging of wearable devices.

12. The system of claim 1, wherein the conductive parts are used in conjunction with a sensor system to enable sensing of human-object interactions.

13. A method for augmenting human-object interaction, the method comprising:
determining, by a processor, one or more surrounding objects in proximity to a conductive medium for transmitting an electro-quasistatic (EQS) signal carrying data from a wearable device to a receiving device, wherein the one or more surrounding object comprises conducting parts;
configuring, by the processor, the one or more surrounding objects with conductive parts that guide the EQS signals;
establishing, by the processor, a communication channel between the wearable device and the receiving device via the conducting medium and the conductive parts; and
transmitting, by the processor, the electro-quasistatic (EQS) signal carrying data from the wearable device to the receiving device via the conducting medium and the conductive parts using a non-radiative, guided communication mode maintaining signal confinement around the user and the conductive parts.

14. The method of claim 13, further comprising:
routing, by the conductive parts, the EQS signal from the conductive parts to the receiving device; and
receiving, by the receiving device, the EQS signal at the receiving device to enable an application-specific interaction.

15. The method of claim 13, further comprising:
adjusting the size and shape of the conductive parts to minimize coupling capacitance to earth ground;
applying application-specific patterns to the conductive parts to maximize electric field strength and voltage pickup at intended communication points; and
establishing interactions between the conductive parts through human structure interactions, comprising at least one of an Inter-Structures Interaction (SSI) and a Human-Structure-Human Interaction (HSHI), using EQS network.

16. The method of claim 13, further comprising:
wirelessly charging wearable devices by using ground-connected or floating-ground electronic devices through the human body, wherein the power transfer enables charging and data communication for devices placed on EQS-augmented surfaces.

17. A non-transitory computer-readable medium comprising machine-readable instructions that are executable by a processor to:
determine one or more surrounding objects in proximity to a conductive medium for transmitting an electro-quasistatic (EQS) signal carrying data from a wearable device to a receiving device, wherein the one or more surrounding object comprises conducting parts;
configure the one or more surrounding objects with conductive parts that guide the EQS signals;
establish a communication channel between the wearable device and the receiving device via the conducting medium and the conductive parts; and
transmit the electro-quasistatic (EQS) signal carrying data from the wearable device to the receiving device via the conducting medium and the conductive parts using a non-radiative, guided communication mode maintaining a signal confinement around the user and the conductive parts.
